(19) United States
(12) Patent Application Publication
(10) Pub. No.: US 2026/0278912 A1
(43) Pub. Date: Sep. 17, 2026

(54) SEMIPROCEDURAL MATERIAL GENERATION

(71) Applicant: thinAir Technologies, Inc., Covington, LA (US)

(72) Inventor: Jeremey Charbonnet, Covington, LA (US)

(21) Appl. No.: 19/555,326

(22) Filed: Mar. 3, 2026

Related U.S. Application Data
(60) Provisional application No. 63/769,935, filed on Mar. 11, 2025.

(51) Int. Cl. G06T 15/04; G06T 17/20

(52) U.S. Cl. CPC G06T 15/04; G06T 17/20

(57) ABSTRACT

In one implementation, a method of rendering an object is performed by a device including one or more processors and non-transitory memory. The method includes storing first object data for a first object including a first mesh and one or more first material parameters. The method includes generating a first material for the first mesh based on the one or more first material parameters and a first set of one or more random values. The method includes rendering the first object based on the first mesh and the first material. The method includes displaying the first object based on the rendering of the first object.

### CROSS-REFERENCE TO RELATED APPLICATIONS

This application claims priority to U.S. Provisional Patent App. No. 63/769,935, filed on Mar. 11, 2025, which is hereby incorporated by reference in its entirety.

### TECHNICAL FIELD

The present disclosure generally relates to systems, methods, and devices of generating materials for virtual objects.

### BACKGROUND

In computer graphics, a virtual object is often associated with a mesh and a material. Based on the material and the mesh, a shader determines pixel values of the object at various pixel locations. In various implementations, the materials reference a texture (e.g., an image).

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A–1F illustrate a virtual environment during various time periods in accordance with some implementations.

FIG. 2 is a flowchart representation of a method of rendering an object in accordance with some implementations.

FIG. 3 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for rendering an object. In various implementations, the method is performed by a device having one or more processors and non-transitory memory. The method includes storing first object data for a first object including a first mesh and one or more first material parameters. The method includes generating a first material for the first mesh based on the one or more first material parameters and a first set of one or more random values. The method includes rendering the first object based on the first mesh and the first material. The method includes displaying the first object based on the rendering of the first object.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

In various implementations, rendering a virtual environment for display includes rendering multiple objects with associated meshes and materials. In various implementations, an object is rendered using a shader applied to a mesh and a material. Although in various implementations, materials and textures are used interchangeably, in various implementations, a texture is simply an image, whereas a material is an asset that references a texture, color, reflectivity, transmissivity, or other property that defines how a surface should look when rendered by a shader.

In various implementations, the texture for an object may be manually designed by a user, captured based on a real-world object, or procedurally generated. Similarly, a material including references to a texture and other optical properties can be manually designed by a user or procedurally generated based on one or more material parameters.

However, even procedurally generated materials may be insufficient to generate a rich virtual environment including naturalistic variation. Accordingly, in various implementations, an electronic device generates a material for an object based on a set of one or more random values. As used herein, random values includes pseudorandom values generated by a pseudorandom number generator (PRNG). In particular, the electronic device semiprocedurally generates a material based on one or more material parameters and a set of random values. For example, in various implementations, the electronic device generates the material using a procedural algorithm applied to the one or more material parameters modified by the set of random values. In various implementations, generating the material based on the set of one or more random values includes generating a texture based on the set of one or more random values (e.g., semiprocedurally).

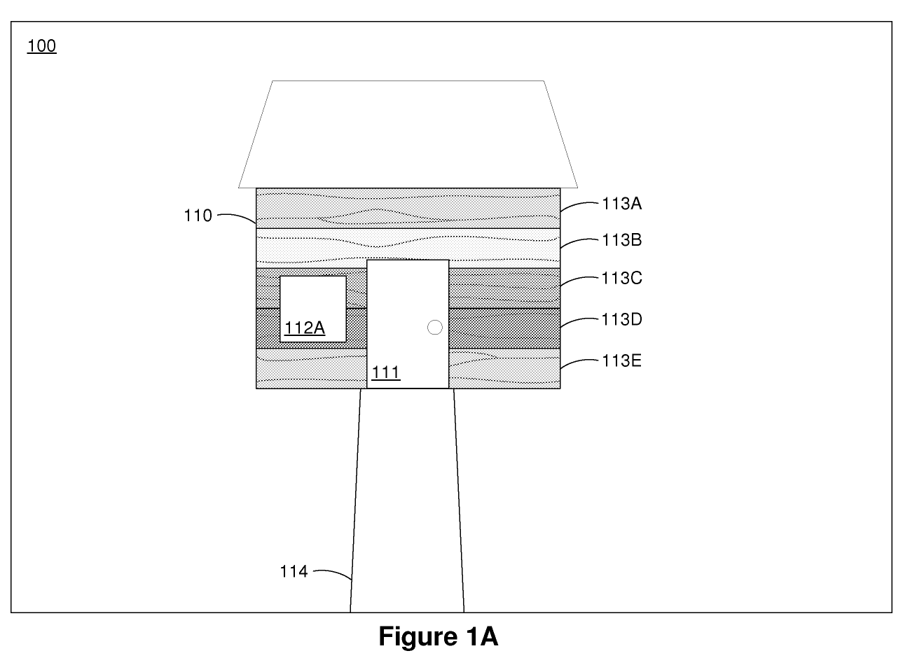

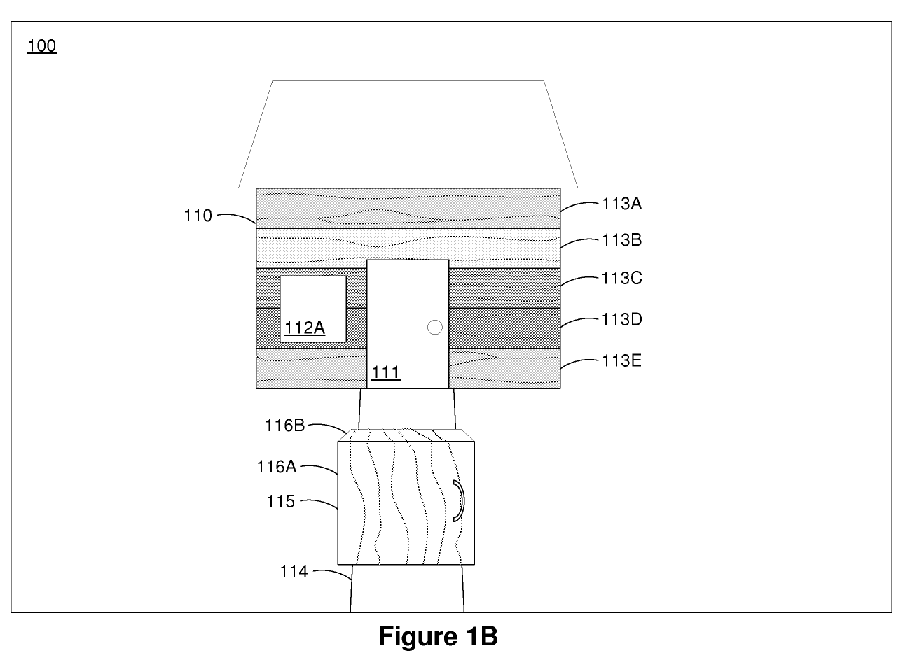

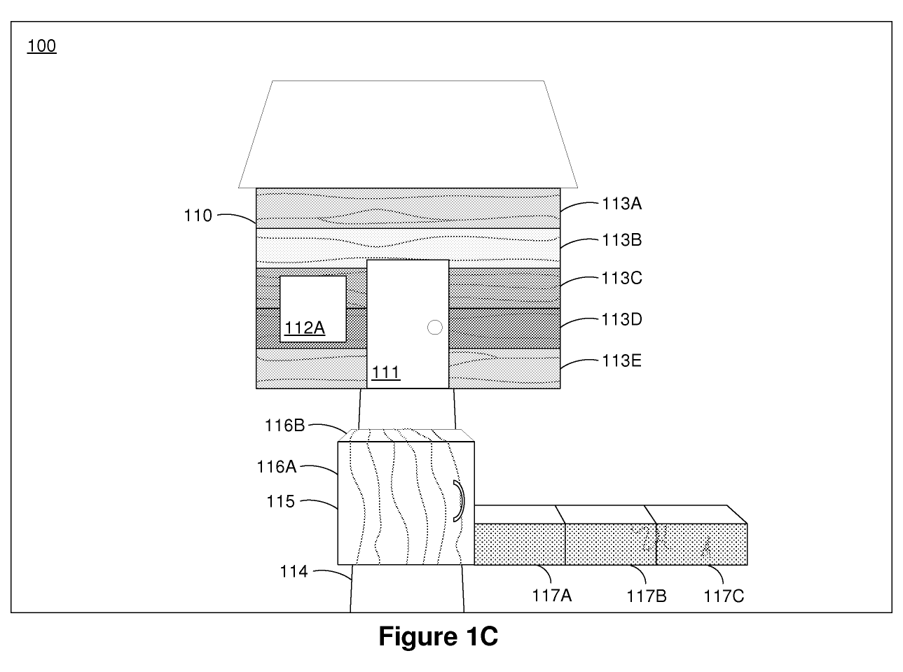

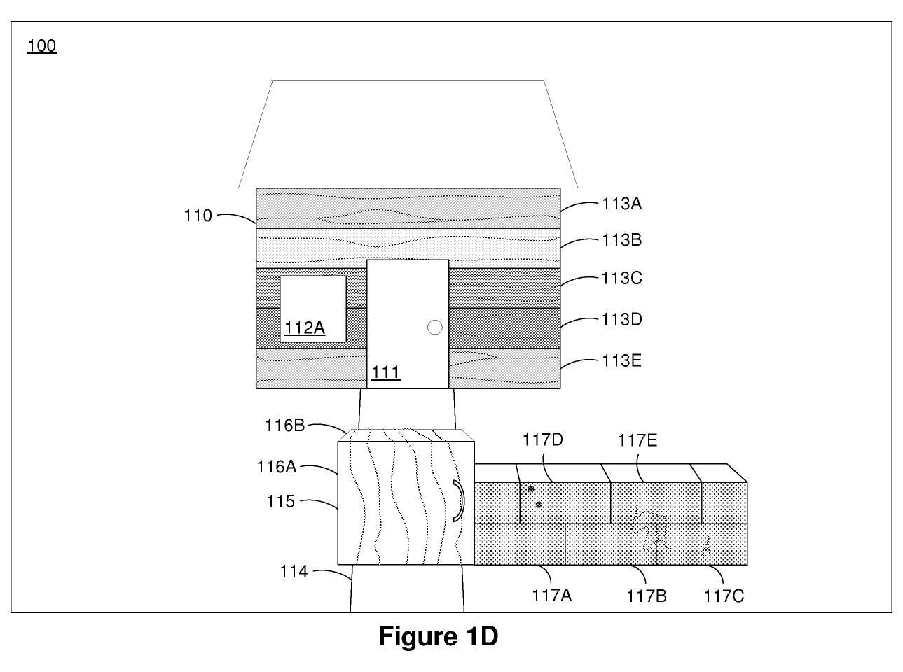

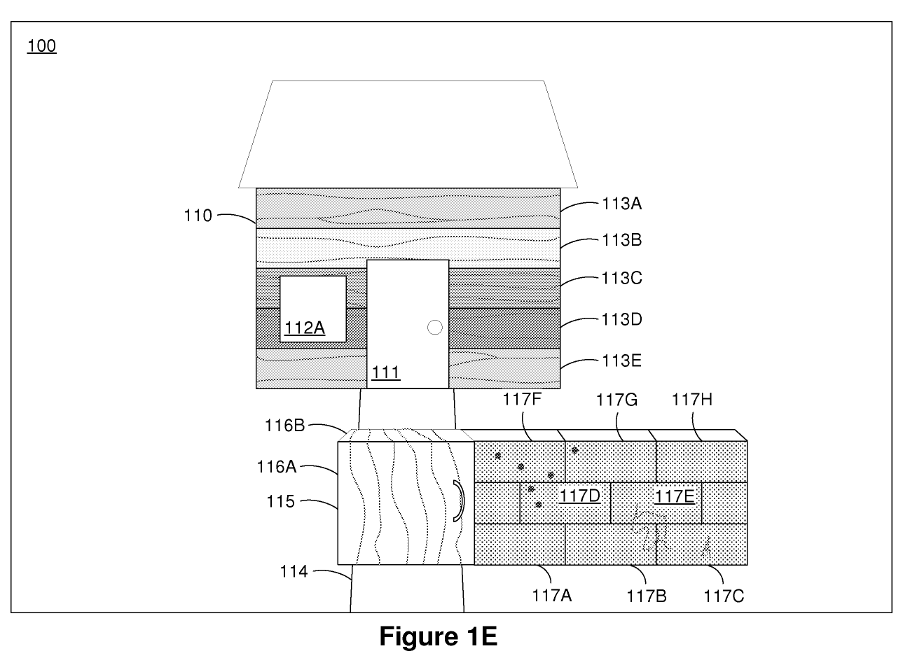

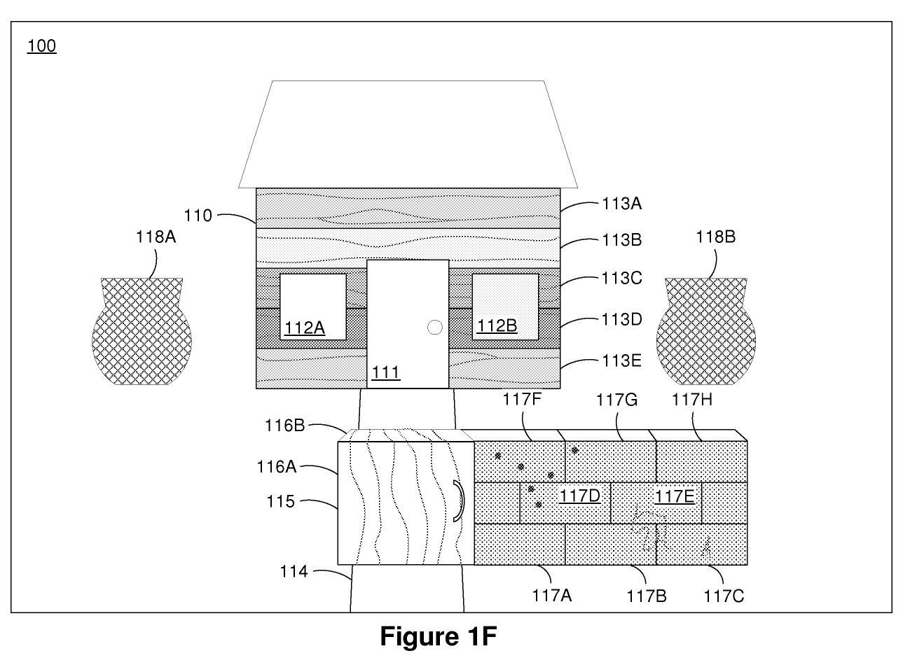

FIGS. 1A–1F illustrate a virtual environment 100 from a rendering perspective displayed, at least in part, by a display of an electronic device. In various implementations, the electronic device includes multiple displays (e.g., a left display positioned in front of a left eye of a user and a right display positioned in front of a right eye of the user) configured to provide a stereoscopic view of the virtual environment 100. For ease of illustration, FIGS. 1A–1F illustrate the virtual environment 100 as presented on a single one of the multiple displays.

FIGS. 1A–1F illustrate the virtual environment 100 during a series of time periods. In various implementations, each time period is an instant, a fraction of a second, a few seconds, a few hours, a few days, or any length of time.

FIG. 1A illustrates the virtual environment 100 during a first time period. During the first time period, the virtual environment 100 includes a house 110 and a sidewalk 114 leading up to house 110. The house 110 includes a door 111, a first window 112A, and wood siding made up of a plurality of wood panels 113A–113E.

Each of the plurality of wood panels 113A–113E is associated with an identical mesh generally defining a thin rectangular prism. Further, each of the plurality of wood panels 113A–113E is associated with a respective (and different) material. In various implementations, the electronic device generates the material for each of the plurality of wood panels 113A–113E based on one or more material parameters and a respective set of random values. In FIG. 1A, the one or more material parameters are the same for each of the plurality of wood panels 113A–113E. However different panels appear differently because the set of random values used to generate the corresponding material are different.

For example, to generate the material for a wood panel, the electronic device obtains the one or more material parameters. For example, the one or more material parameters can include a base color value, a ring density, knot frequency, a grain variation, a cleanliness, a mossiness, etc. Applying a wood material generating algorithm based on these values would result in each of the plurality of wood panels 113A–113E being identically generated. Accordingly, in various implementations, the electronic device, for each of the plurality of wood panels 113A–113E generates one or more modified material parameters based on a set of one or more random values and applies the wood material generating algorithm based on the modified material parameters. Accordingly, each of the plurality of wood panels 113A–113E is slightly different. In particular, the texture of each of the plurality of wood panels 113A–113E is different, but generated based on the same wood material generating algorithm.

FIG. 1B illustrates the virtual environment 100 during a second time period subsequent to the first time period. Between the first time period and the second time period, a user has added a wooden gate 115 on the sidewalk 114 in front of the house 110. The wooden gate 115 has a front surface 116A and a top surface 116B. In various implementations, the electronic device generates a material for the front surface 116A and the top surface 116B. For example, in various implementations, the electronic device obtains the one or more material parameters for each surface and applies the wood material generating algorithm to based on those values. Notably, in FIG. 1B, the one or more material parameters for the wooden gate 115 are different than the one or more material parameters for the plurality of wood panels 113A–113E (which are a darker wood with less grain density than the wooden gate 115). However, applying the wood material generating algorithm to each face separately might result in inconsistencies at the edge formed by the front surface 116A and top surface 116B. For example, a ring on the front surface 116A may not be continuous with a ring on the top surface 116B making it appear as though the wooden gate 115 is not a solid piece of wood, but plastered with fake wood grain veneer.

Accordingly, in various implementations, the electronic device generates the material for the wooden gate 115 by generating a first texture for the front surface 116A and a second texture for the top surface 116B which is based on the first texture for the front surface 116A. Although each may be generated by applying the wood material generating algorithm, the one or more material parameters are selected and/or modified to ensure consistency, continuity, and/or continuousness between the first texture and the second texture, e.g., to enforce a boundary condition.

FIG. 1C illustrates the virtual environment 100 during a third time period subsequent to the second time period. Between the second time period and the third time period, a user has added a first brick 117A, a second brick 117B, and a third brick 117C next to the wooden gate 115. In various implementations, the electronic device generates a material for the first brick 117A, the second brick 117B, and the third brick 117C. For example, in various implementations, the electronic device obtains one or more material parameters and applies a brick material generating algorithm based on those values. However, applying the brick material generating algorithm with the same material parameters for each brick would result in unnatural uniformity. Accordingly, in various implementation, the material parameters are randomly modified before being applied to the brick material generating algorithm.

Accordingly, in FIG. 1C, the front surface of the first brick 117A contains no markings, a front surface of the second brick 117B contains a portion of a scratch, and a front surface of the third brick 117C includes another portion of the scratch and a chip in the center of the front surface. Notably, the scratch spans the textures for two different objects. In various implementations, generating the material for an object is based on the set of one or more random values for another object. In particular, in various implementations, generating the material for an object is based on the material of another object. Even more particular, in various implementations, generating the texture for an object is based on the texture of another object. For example, in various implementations, generating the texture for an object includes enforcing a boundary condition set by the texture of the other object.

FIG. 1D illustrates the virtual environment 100 during a fourth time period subsequent to the third time period. Between the third time period and the fourth time period, a user has added a fourth brick 117D and a fifth brick 117E on top of the first brick 117A, the second brick 117B, and the third brick 117C. In various implementations, the electronic device generates materials for the fourth brick 117D and the fifth brick 117E. Notably, in FIG. 1D, the front surface of the fourth brick 117D contains a number of pock marks and the front surface of the fifth brick 117E contains another portion of the scratch.

FIG. 1E illustrates the virtual environment 100 during a fifth time period subsequent to the fourth time period. Between the fourth time period and the fifth time period, the user has added a sixth brick 117F, a seventh brick 117G, and an eighth brick 117H. In various implementations, the electronic device generates materials for the sixth brick 117F, the seventh brick 117G, and the eighth brick 117H. Notably, in FIG. 1E, the front surface of the sixth brick 117F contains a number of pock marks, the front surface of the seventh brick 117G contains a single pock mark, and the front surface of the eighth brick 117H contains no marks. In various implementations, the electronic device generates the material for an object based on the materials of proximate objects. Accordingly, the distribution of pock marks along the wall formed by the plurality of bricks 117A–117H is centralized to the upper left. Thus, whereas the scratch is distributed across a number of bricks due to enforcement of boundary conditions, the distribution of pock marks is more relaxed condition, but still consistent across multiple objects.

FIG. 1F illustrates the virtual environment 100 during a sixth time period subsequent to the fifth time period. Between the fifth time period and the sixth time period, a user has added a second window 112B to the house 110, a first planter 118A, and a second planter 118B. The electronic device generates a material for the second window 112B by obtaining one or more material parameters for the window, modifying the one or more material parameters based on a set of random values, and applying a window material generating algorithm to generate the material for the second window 112B. Notably, the material for the second window 112B and the material for the first window 112A have the same texture and differ only in their radiative optical properties, e.g., reflectivity and/or transmissivity. For example, in FIG. 1F, the second window 112B appears slightly tinted as compared to the first window 112A. The electronic device generates materials for the first planter 118A and the second planter 118B by obtaining one or more material parameters for the planters, modifying them based on two different sets of random values, and applying a planter material generating algorithm to generate the materials for the first planter 118A and the second planter 118B. Notably, the material for the second planter 118B and the material for the first planter 118A have the same texture and differ only in their color. For example, in FIG. 1F, the second planter 118B appears slightly darker than the first planter 118A.

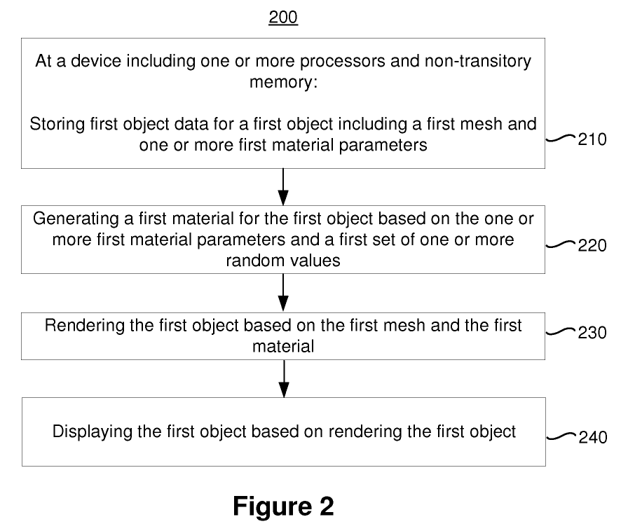

FIG. 2 is a flowchart representation of a method 200 of rendering an object in accordance with some implementations. In various implementations, the method 200 is performed by an electronic device. In various implementations, the method 200 is performed by a device having one or more processors and non-transitory memory. In some implementations, the method 200 is performed by processing logic, including hardware, firmware, software, or a combination thereof. In some implementations, the method 200 is performed by a processor executing instructions (e.g., code) stored in a non-transitory computer-readable medium (e.g., a memory).

The method 200 begins, in block 210, with the device storing first object data for a first object including a first mesh and one or more first material parameters. In various implementations, the one or more first material parameters includes a texture, a color, a reflectivity, and/or a transmissivity. In various implementations, the texture includes an image, such as a bitmap, a PNG file, a TGA file, or any other file format. In various implementations, the one or more first material parameters include parameters for a material generating algorithm. For example, for a wood material generating algorithm, the one or more first material parameters can include a base color value, a ring density, knot frequency, and/or a grain variation. As another example, for a brick material generating algorithm, the one or more first material parameters can include a color, a composition, a mortar width, and/or a weathering condition. In various implementations, the one or more first material parameters for a material generating algorithm can include a seed value. In various implementations, the first object data includes additional information regarding the first object such as a position and/or orientation.

The method 200 continues, in block 220, with the device generating a first material for the first mesh based on the one or more first material parameters and a first set of one or more random values. In various implementations, the device generates the first material for the first mesh using a material generating algorithm applied to the one or more first material parameters modified by the first set of one or more random values. In various implementations, the one or more first material parameters are predefined, e.g., by user input. Thus, in various implementations, the method 200 includes receiving user input indicative of the one or more first material parameters.

In various implementations, the first set of one or more random values are instances of one or more random variables (which may be in a one-to-one relationship or one-to-many relationship with the first set of one or more random values). In various implementations, the random variables are defined by random variable parameters stored in the first object data. For example, the random variable parameters can include a random variable type (e.g., uniform, exponential, Guaussian, etc.) and one or more random variable parameters include moments of the random variable (e.g., mean, variance, skewness, etc.). In various implementations, the one or more random variable parameters includes other parameters defining the random variable, such as a minimum or maximum.

In various implementations, a particular one of the first material parameters is modified by adding the particular one of the first material parameters to a particular random value, multiplying the particular one of the first material parameters by a particular random value, or replacing the particular one of the first material parameters with a particular random value.

In various implementations, generating the first material for the first mesh includes generating a first texture based on at least one of the first set of one or more random values. For example, in FIG. 1A, the respective textures for each of the plurality of wood panels 113A–113E are generated based on respective sets of random values. In various implementations, generating the first texture includes generating a first face texture for a first face of the first mesh and generating a second face texture for a second face of the first mesh. For example, in FIG. 1B, the electronic device generates a first texture for the front surface 116A of the wooden gate 115 and a second texture for the top surface 116B of the wooden gate 115. In various implementations, generating the second face texture for the second face of the first mesh is based on the first face texture for the first face of the first mesh. For example, in FIG. 1B, the second texture for the top surface 116B of the wooden gate 115 is generated to make the rings of the first texture for the front surface 116A of the wooden gate 115 continuous.

In various implementations, the texture for a material is not based on the set of one or more random values, but other properties of the material are based on the set of one or more random values. For example, in various implementations, generating the first material for the first mesh includes generating a first color based on at least one of the first set of one or more random values. For example, in FIG. 1F, the textures for the first planter 118A and the second planter 118B are the same, but the materials for the first planter 118A and the second planter 118B have different colors. In various implementations, generating the first material for the first mesh includes generating a first radiative optical property based on at least one of the first set of one or more random values. For example, in FIG. 1F, the textures for the first window 112A and the second window 112B are the same, but the materials for the first window 112A and the second window 112B have different reflectivity and/or transmissivity. In various implementations, generating the first material for the first mesh includes generating a first texture and at least one additional property of the material based on the set of one or more random values.

The method 200 continues, in block 230, with the device rendering the first object based on the first mesh and the first material. In various implementations, the first object is rendered by a shader. The method 200 continues, in block 240, with the device displaying the first object based on rendering the first object. In various implementations, the first object is displayed by a graphics processing unit and/or a physical display.

In various implementations, the method 200 includes displaying a virtual environment containing multiple objects. To that end, in various implementations, the method 200 includes (in similar fashion as blocks 210–240) storing second object data for a second object including a second mesh and one or more second material parameters; generating a second material for the second mesh based on the one or more second material parameters and a second set of one or more random values; rendering the second object based on the second mesh and the second material; and displaying the second object based on the rendering of the second object.

In various implementations, the one or more second material parameters are the same as the one or more first material parameters and the second set of one or more random values is different than the first set of one or more random values. For example, in FIG. 1A, the material for each of the plurality of wood panels 113A–113E are generated based on the same material parameters (modified differently by different random values) applied to the same wood material generating algorithm.

In various implementations, generating the second material is based on the first set of one or more random values. In particular, in various implementations, generating the second material is based on the first material. In particular, in various implementations, generating the first material includes generating a first texture, generating the second material includes generating a second texture, and the second texture is based on the first texture. For example, in various implementations, generating the second texture includes enforcing a boundary condition set by the first texture. For example, in FIG. 1F, the texture of the front surface of the fifth brick 117E is based on the texture of the front surface of the second brick 117B to ensure continuity of the scratch. In various implementations, generating the second material is based on a distance between the first object and the second object. For example, in FIG. 1F, the texture of the front surface of the sixth brick 117F has a pock mark density based on the pock mark density of the texture of the front surface of the fourth brick 117D and its proximity of the sixth brick 117F to the fourth brick 117D.

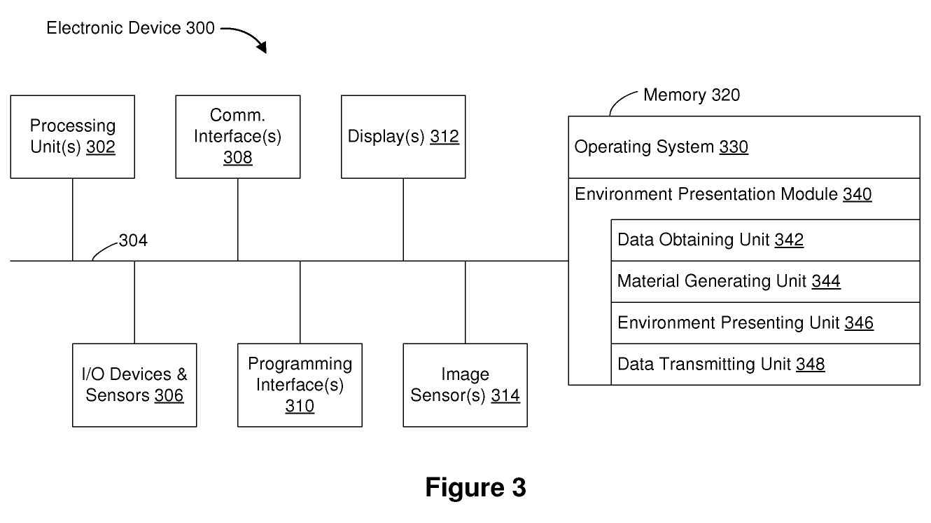

FIG. 3 is a block diagram of an example of an electronic device 300 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 300 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 312 are configured to display a virtual environment. In some implementations, the one or more displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 312 correspond to diffractive, reflective, polarized, holographic, etc. waveguide displays. In one example, the electronic device 300 includes a single display. In another example, the electronic device includes a display for each eye of the user. In some implementations, the one or more displays 312 are capable of presenting XR (extended reality) and VR (virtual reality) content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the physical environment as would be viewed by the user if the electronic device 300 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an environment presentation module 340.

The operating system 330 includes procedures for handling various basic system services and for performing hardware dependent tasks. In some implementations, the environmental presentation module 340 is configured to present a scene composing user interface to the user via the one or more displays 312. To that end, in various implementations, the environmental presentation module 340 includes a data obtaining unit 342, a material generating unit 344, an environmental presenting unit 346, and a data transmitting unit 348.

In some implementations, the data obtaining unit 342 is configured to obtain data (e.g., presentation data, interaction data, sensor data, location data, etc.) from the other components of the electronic device 300 and/or a different electronic device. To that end, in various implementations, the data obtaining unit 342 includes instructions and/or logic therefor, and heuristics and metadata therefor.

In some implementations, the material generating unit 344 is configured to generate material for objects based on material parameters and random values. To that end, in various implementations, the material generating unit 344 includes instructions and/or logic therefor, and heuristics and metadata therefor.

In some implementations, the environmental presenting unit 346 is configured to, in response to user input, present a virtual environment including the objects with the generated materials. To that end, in various implementations, the environmental presenting unit 346 includes instructions and/or logic therefor, and heuristics and metadata therefor.

In some implementations, the data transmitting unit 348 is configured to transmit data (e.g., presentation data, location data, etc.) to other components of the electronic device 300 and/or a different electronic device. To that end, in various implementations, the data transmitting unit 348 includes instructions and/or logic therefor, and heuristics and metadata therefor.

Although the data obtaining unit 342, the material generating unit 344, the environmental presenting unit 346, and the data transmitting unit 348 are shown as residing on a single device (e.g., the electronic device 300), it should be understood that in other implementations, any combination of the data obtaining unit 342, the material generating unit 344, the environmental presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having one or more processors and non-transitory memory:
storing first object data for a first object including a first mesh and one or more first material parameters;
generating a first material for the first mesh based on the one or more first material parameters and a first set of one or more random values;
rendering the first object based on the first mesh and the first material; and
displaying the first object based on the rendering of the first object.

2. The method of claim 1, wherein generating the first material for the first mesh includes generating a first texture based on at least one of the first set of one or more random values.

3. The method of claim 2, wherein generating the first texture includes generating a first face texture for a first face of the first mesh and generating a second face texture for a second face of the first mesh.

4. The method of claim 3, wherein generating the second face texture for the second face of the first mesh is based on the first face texture for the first face of the first mesh.

5. The method of claim 1, wherein generating the first material for the first mesh includes generating a first color based on at least one of the first set of one or more random values.

6. The method of claim 1, wherein generating the first material for the first mesh includes generating a first radiative optical property based on at least one of the first set of one or more random values.

7. The method of claim 1, further comprising, receiving user input indicative of the one or more first material parameters.

8. The method of claim 1, further comprising:
storing second object data for a second object including a second mesh and one or more second material parameters;
generating a second material for the second mesh based on the one or more second material parameters and a second set of one or more random values;
rendering the second object based on the second mesh and the second material; and
displaying the second object based on the rendering of the second object.

9. The method of claim 8, wherein the one or more second material parameters are the same as the one or more first material parameters and the second set of one or more random values is different than the first set of one or more random values.

10. The method of claim 8, wherein generating the second material is based on the first set of one or more random values.

11. The method of claim 10, wherein generating the second material is based on the first material.

12. The method of claim 11, wherein generating the first material includes generating a first texture, wherein generating the second material includes generating a second texture, and wherein the second texture is based on the first texture.

13. The method of claim 12, wherein generating the second texture includes enforcing a boundary condition set by the first texture.

14. The method of claim 10, wherein generating the second material is based on a distance between the first object and the second object.

15. A device comprising:
a non-transitory memory; and
one or more processors to:
store first object data for a first object including a first mesh and one or more first material parameters;
generate a first material for the first mesh based on the one or more first material parameters and a first set of one or more random values;
render the first object based on the first mesh and the first material; and
display the first object based on the rendering of the first object.

16. The device of claim 15, wherein the one or more processors are to generate the first texture by generating a first face texture for a first face of the first mesh and generating a second face texture for a second face of the first mesh based on the first face textures for the first face of the first mesh.

17. The device of claim 15, wherein the one or more processors are further to:
store second object data for a second object including a second mesh and one or more second material parameters;
generate a second material for the second mesh based on the one or more second material parameters and a second set of one or more random values;
render the second object based on the second mesh and the second material; and
display the second object based on the rendering of the second object.

18. The device of claim 17, wherein the one or more processors are to generate the second material based on the first material.

19. The device of claim 18, wherein the one or more processors are to generate the second material by enforcing a boundary condition set by the first material.

20. A non-transitory memory storing one or more programs, which, when executed by one or more processors of a device, cause the device to:
store first object data for a first object including a first mesh and one or more first material parameters;
generate a first material for the first mesh based on the one or more first material parameters and a first set of one or more random values;
render the first object based on the first mesh and the first material; and
display the first object based on the rendering of the first object.
